(19) United States
(12) Patent Application Publication
(10) Pub. No.: US 2016/0124338 A1
(43) Pub. Date: May 5, 2016

(54) NEUTRALIZATION DEVICE, NEUTRALIZATION METHOD AND IMAGE FORMING APPARATUS

(71) Applicant: KYOCERA Document Solutions Inc., Osaka (JP)

(72) Inventor: Takashi KUSUKAWA, Osaka (JP)

(73) Assignee: KYOCERA Document Solutions Inc., Osaka (JP)

(21) Appl. No.: 14/925,517

(22) Filed: Oct. 28, 2015

(30) Foreign Application Priority Data
Oct. 31, 2014 (JP) 2014-222705

(51) Int. Cl. G03G 15/043

(52) U.S. Cl. CPC G03G 15/043

(57) ABSTRACT

There are provided a neutralization device, a neutralization method and an image forming apparatus including such a neutralization device. In the neutralization device that includes a plurality of light sources and that applies neutralization light to the charged circumferential surface of the photosensitive drum from the light sources to neutralize the photosensitive drum, the amount of neutralization light on the circumferential surface of the photosensitive drum can be made constant in the drum shaft direction. The neutralization device includes a light amount control wall portion that is extended in the drum shaft direction, and corresponding portions between the light sources adjacent to each other in the light amount control wall portion are formed in such a shape or formed of such a material that the amount of the neutralization light on the circumferential surface of the photosensitive drum is made constant in the drum shaft direction.

This application is based upon and claims the benefit of priority from the corresponding Japanese Patent Application No. 2014-222705 filed on Oct. 31, 2014, the entire contents of which are incorporated herein by reference.

### BACKGROUND

The present disclosure relates to a neutralization device, a neutralization method and an image forming apparatus including such a neutralization device.

Conventionally, in an image formation process in an electrophotographic image forming apparatus, writing processing such as by optical scanning is first performed on a photosensitive drum uniformly charged by a charging device to form an electrostatic latent image, and the electrostatic latent image is developed with a development device. Then, a toner image obtained by the development is transferred from the circumferential surface of the photosensitive drum to a transfer member such as recording paper or an intermediate transfer member. Although a residual charge is present on the photosensitive drum on which the transfer processing has been performed, the residual charge is removed with a neutralization device. Neutralization is performed on the photosensitive drum with such a neutralization device, and thus the writing processing is prevented from being performed on the subsequent images with the history of the electrostatic latent image left on the photosensitive drum. The neutralization device includes a substrate and a plurality of light-emitting diodes attached to the substrate. The light-emitting diodes are arranged a distance apart from each other in the direction of the shaft of the photosensitive drum (hereinafter referred to as a drum shaft direction).

However, in the conventional image forming apparatus described above, since a plurality of light-emitting diodes (light sources) forming the neutralization device are arranged a distance apart in the drum shaft direction, on the circumferential surface of the photosensitive drum, parts having a large amount of neutralization light and parts having a small amount of neutralization light are alternately produced in the drum shaft direction. Hence, on the circumferential surface of the photosensitive drum, the amount of neutralization light is not uniform in the drum shaft direction. Consequently, it is disadvantageously impossible to sufficiently remove, with the neutralization device, the history of the electrostatic latent image left on the photosensitive drum.

### SUMMARY

According to one aspect of the present disclosure, a neutralization device includes a plurality of light sources arranged a distance apart from each other in the direction of the shaft of a photosensitive drum and applies neutralization light to the circumferential surface of the photosensitive drum from the light sources to neutralize the photosensitive drum. The neutralization device includes: a light amount control wall portion that is provided in an optical path of the neutralization light travelling from the light sources to the photosensitive drum and that is extended in the drum shaft direction, and corresponding portions between the light sources adjacent to each other in the light amount control wall portion are formed in such a shape or formed of such a material that the amount of the neutralization light on the circumferential surface of the photosensitive drum is made constant in the drum shaft direction, and that as compared with portions corresponding to the light sources in the light amount control wall portion, the neutralization light is easily transmitted.

According to one aspect of the present disclosure, there is provided a neutralization method of the neutralization device of the above configuration. When the neutralization light is applied from the light sources to the circumferential surface of the photosensitive drum to neutralize the photosensitive drum, in the optical path of the neutralization light travelling from the light sources to the photosensitive drum, the light amount control wall portion extending in the drum shaft direction is provided, the corresponding portions between the light sources adjacent to each other in the light amount control wall portion are formed in such a shape or formed of such a material that as compared with the portions corresponding to the light sources, the light is easily transmitted and the amount of the neutralization light on the circumferential surface of the photosensitive drum is made constant in the drum shaft direction.

According to one aspect of the present disclosure, there is provided an image forming apparatus including: a plurality of image formation units each including a photosensitive drum that is driven to rotate in a predetermined rotation direction, a charging device that charges the photosensitive drum, a development device that supplies a toner to the circumferential surface of the photosensitive drum and the neutralization device of the above configuration that neutralizes the photosensitive drum; an endless transfer belt that makes contact with a plurality of the photosensitive drums in the image formation units and that is driven to rotate while the circumferential surface thereof is in contact with the photosensitive drums; and a plurality of transfer rollers that are arranged through the transfer belt opposite the photosensitive drums and that transfer a toner image to the transfer belt.

The neutralization device performs pre-transfer neutralization in which the neutralization light is applied to an upstream side in the rotation direction with respect to a position on the circumferential surface of the photosensitive drum opposite the transfer roller and post-transfer neutralization in which the neutralization light is applied to a downstream side in the rotation direction with respect to the position on the circumferential surface of the photosensitive drum opposite the transfer roller, the amount of the neutralization light for the pre-transfer neutralization is set lower than the amount of the neutralization light for the post-transfer neutralization and the light amount control wall portion is provided in an optical path of the neutralization light for the pre-transfer neutralization.

### BRIEF DESCRIPTION OF THE DRAWINGS

FIG. 1 A schematic overall diagram showing an image forming apparatus according to the present embodiment;

FIG. 2 A cross-sectional view showing a drum unit and taken along a cross section perpendicular to the direction of the shaft of a photosensitive drum;

FIG. 3 An illustrative diagram for illustrating the configuration of a neutralization device;

FIG. 4 A schematic diagram showing an optical path of neutralization light emitted from the neutralization device;

FIG. 5 An enlarged perspective view of image formation units adjacent to each other;

FIG. 6 A cross-sectional view showing an upper side cover portion of a development unit and taken along a cross section perpendicular to the direction of the shaft of the photosensitive drum;

FIG. 7 A perspective view showing the upper side cover portion of the development unit;

FIG. 8 An illustrative diagram for illustrating a positional relationship between cut portions formed in the light amount control wall portion of the upper side cover portion and light-emitting diodes 35 for pre-transfer neutralization; and

FIG. 9 A diagram corresponding to FIG. 8 showing a second embodiment.

### DETAILED DESCRIPTION

Embodiments of the present disclosure will be described in detail below with reference to drawings. The present disclosure is not limited to the embodiments described below.

### First Embodiment

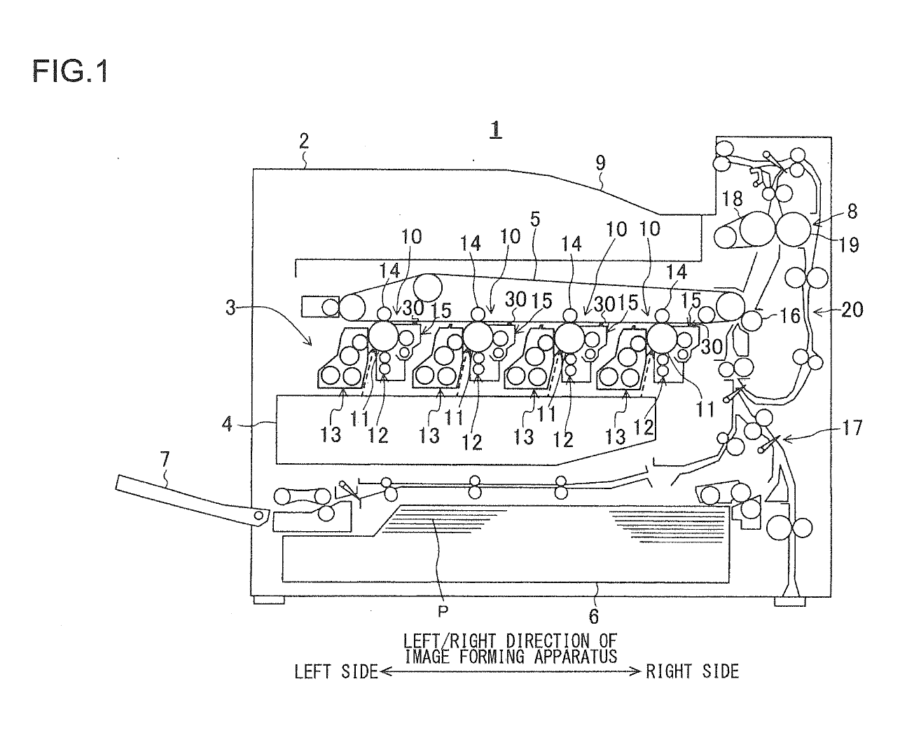

FIG. 1 shows a schematic diagram showing the configuration of an image forming apparatus 1 according to an embodiment of this disclosure. In the following description, the front side and the back side refer to the front side and the back side (the front side and the back side in a direction perpendicular to the plane of the figure in FIG. 1) of the image forming apparatus 1, and the left side and the right side refer to the left side and the right side when the image forming apparatus 1 is seen from the front side.

The image forming apparatus 1 described above is a tandem-type color printer, and includes an image formation portion 3 within a box-shaped casing 2. The image formation portion 3 is a portion that transfers and forms an image onto recording paper P based on image data transmitted from an external device such as a computer where a network connection or the like is achieved. Below the image formation portion 3, an exposure device 4 that emits laser light is arranged, and above the image formation portion 3, a transfer belt 5 is arranged. Below the exposure device 4, a sheet storage portion 6 in which the recording paper P is stored is arranged, and on the side to the sheet storage portion 6, a manual paper feed portion 7 is arranged. Above the side of the transfer belt 5, a fixing portion 8 is arranged that performs fixing processing on the image transferred and formed onto the recording paper P. Reference numeral 9 represents a sheet ejection portion which is arranged in an upper portion of the casing 2 and to which the recording paper P subjected to the fixing processing in the fixing portion 8 is ejected.

The image formation portion 3 includes four image formation units 10 that are arranged in a row along the transfer belt 5. These image formation units 10 include photosensitive drums 11. Immediately below each of the photosensitive drums 11, a charging unit 12 is arranged, on one side of each of the photosensitive drums 11, a development device 13 is arranged, immediately above each of the photosensitive drums 11, a primary transfer roller 14 is arranged and on the other side of each of the photosensitive drums 11, a cleaning portion 15 that cleans the circumferential surface of the photosensitive drum 11 is arranged. On the upper end portion of the cleaning portion 15, a neutralization device 30 is arranged. The details of the neutralization device 30 will be described later.

In each of the photosensitive drums 11, the circumferential surface is uniformly charged by the charging unit 12, laser light corresponding to each color based on the image data input from the computer or the like described above is applied from the exposure device 4 to the charged circumferential surface of the photosensitive drum 11 and an electrostatic latent image is formed on the circumferential surface of each of the photosensitive drums 11. A developer is supplied to the electrostatic latent image from the development device 13, and on the circumferential surface of each of the photosensitive drums 11, a toner image of yellow, magenta, cyan or black is formed. These toner images are transferred to the transfer belt 5 by a transfer bias applied to the primary transfer roller 14 so as to be overlaid on each other.

Reference numeral 16 represent a secondary transfer roller that is arranged below the fixing portion 8 so as to be in contact with the transfer belt 5, the recording paper P transported from the sheet storage portion 6 or the manual paper feed portion 7 along a sheet transport path 17 is sandwiched between the secondary transfer roller 16 and the transfer belt 5 and the toner image on the transfer belt 5 is transferred to the recording paper P by the transfer bias applied to the secondary transfer roller 16.

The fixing portion 8 includes a heating roller 18 and a pressure roller 19, the recording paper P is sandwiched between the heating roller 18 and the pressure roller 19 and is heated while being pressurized and thus the toner image transferred to the recording paper P is fixed to the recording paper P. The recording paper P on which the fixing processing has been performed is ejected to the sheet ejection portion 9. Reference numeral 20 represents a reverse transport path for reversing the recording paper P ejected from the fixing portion 8 when double-sided printing is performed.

The neutralization device 30 described above can perform pre-transfer neutralization in which before the toner image is primarily transferred by the primary transfer roller 14, neutralization light is applied to the circumferential surface of the photosensitive drum 11 and post-transfer neutralization in which after the primary transfer, neutralization light is applied to the circumferential surface of the photosensitive drum 11. In addition to the post-transfer neutralization, the pre-transfer neutralization is performed, and thus it is possible to reliably remove a residual charge on the circumferential surface of the photosensitive drum 11. The neutralization device 30 located on the rightmost side of FIG. 1 among the four neutralization devices 30 performs only the post-transfer neutralization because the image formation unit 10 adjacent to the right side is not present.

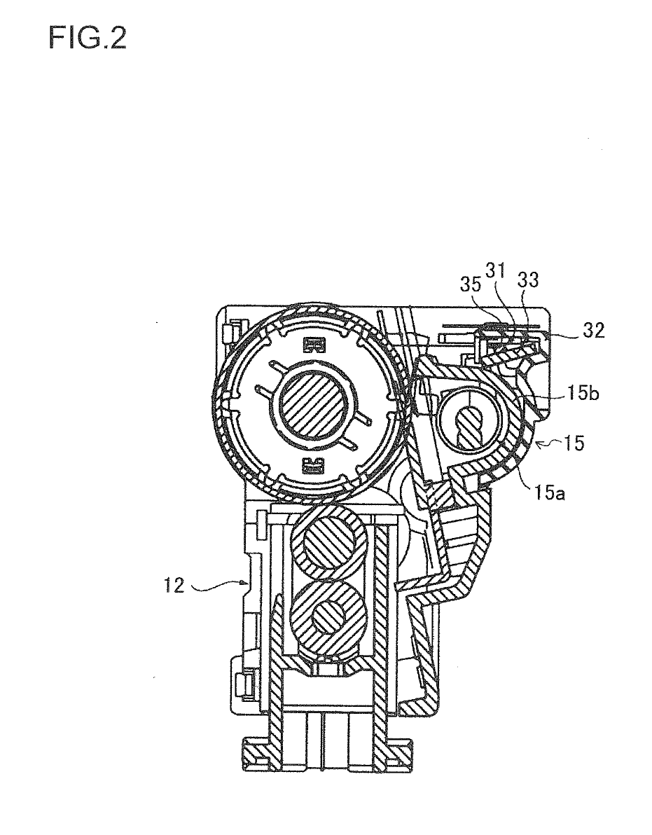

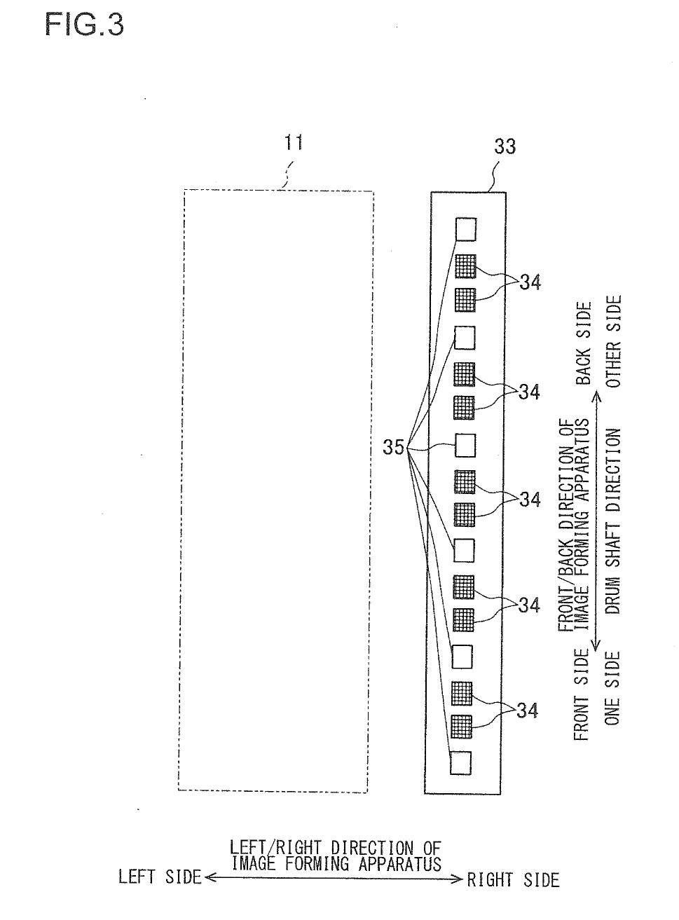

FIGS. 2 and 3 show the neutralization device 30 that can perform both the post-transfer neutralization and the pre-transfer neutralization. This neutralization device 30 includes a light source unit 31 and a light source cover 32.

The light source cover 32 is attached to an outer shell case 15b that holds a cleaning roller 15a and the like, and covers the light source unit 31 so as to prevent scattered toner and foreign substances within the image forming apparatus 1 from being adhered to the light source unit 31. Specifically, the light source cover 32 covers the light source unit 31 from one end to the other end in the length direction of the light source unit 31. The light source cover 32 is formed in the shape of the letter L in cross section so as to cover the upper side and the right side of the light source unit 31 when seen in the longitudinal direction. The light source cover 32 is formed of a material having translucency, for example, a transparent or translucent resin material.

The light source unit 31 includes a substrate 33, a plurality of light-emitting diodes 34 for the post-transfer neutralization that are attached onto the substrate 33, a plurality of light-emitting diodes 35 for the pre-transfer neutralization that are attached onto the substrate 33 and a drive circuit (not shown) that is formed on the substrate 33 and that controls the light emission operation of the light-emitting diodes 34 and 35. Although the neutralization device 30 (the neutralization device 30 located on the rightmost side) that performs only the post-transfer neutralization does not include the light-emitting diodes 35 for the pre-transfer neutralization, since the other configurations are the same as those of the other three neutralization devices 30, the description thereof will be omitted.

The substrate 33 is formed in the shape of a rectangle that is longer in the direction of the shaft of the photosensitive drum 11 (hereinafter referred to as a drum shaft direction), and has a length dimension substantially equal to the dimension of the photosensitive drum 11 in the direction of the shaft. The substrate 33 is arranged parallel to the drum shaft direction and is attached to the upper end portion of the outer shell case 15b of the cleaning portion 15. The light-emitting diodes 34 for the post-transfer neutralization and the light-emitting diodes 35 for the pre-transfer neutralization are aligned in a row parallel to the drum shaft direction. Six light-emitting diodes 35 for the pre-transfer neutralization are provided, and are arranged at regular intervals in the drum shaft direction. Two light-emitting diodes 34 for the post-transfer neutralization are provided between the light-emitting diodes 35 adjacent to each other such that a total of ten light-emitting diodes 34 are provided. The number of light-emitting diodes 34 for the post-transfer neutralization is larger than the number of light-emitting diodes 35 for the pre-transfer neutralization. Hence, in the present embodiment, the amount of neutralization light for the post-transfer neutralization (hereinafter referred to as post-transfer neutralization light) L1 is larger than the amount of neutralization light for the pre-transfer neutralization (hereinafter referred to as pre-transfer neutralization light) L2 by an amount of light corresponding to a number of light-emitting diodes 35 serving as the light source obtained by subtracting the number of light-emitting diodes 34 from the number of light-emitting diodes 35. The number of light-emitting diodes 34 and the number of light-emitting diodes 35 are not limited to this example, and they are preferably two or more.

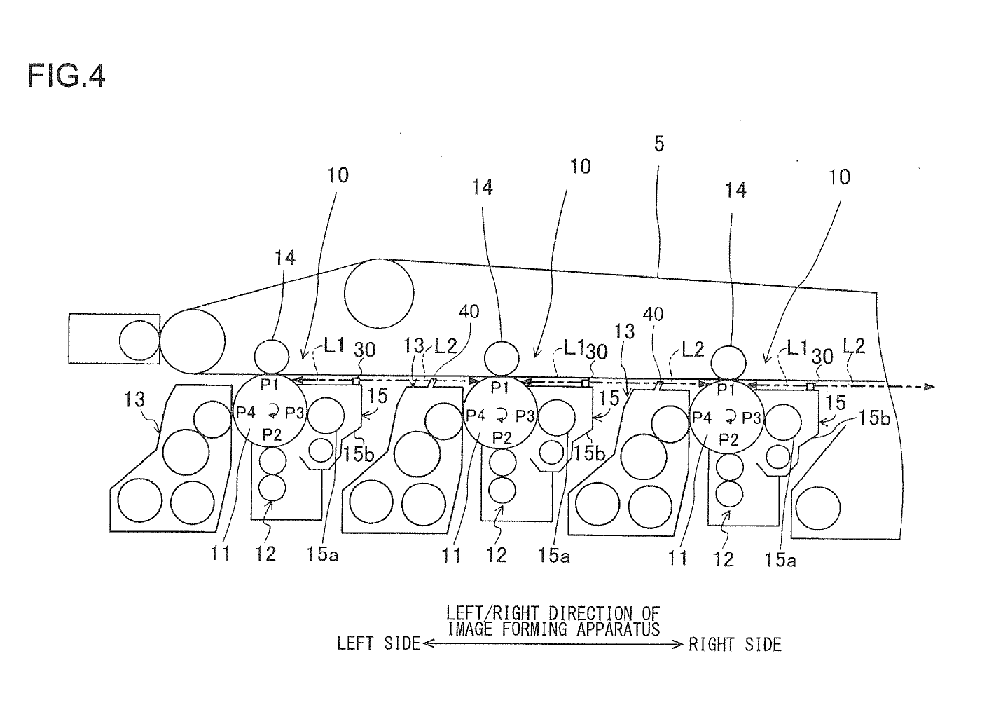

FIG. 4 is schematic diagram showing how the post-transfer neutralization and the pre-transfer neutralization are performed by the neutralization device 30. The direction of the light-emitting diodes 34 for the post-transfer neutralization is set such that the neutralization light L1 emitted from the light-emitting diodes 34 is applied to the downstream side (more specifically, between a primary transfer position P1 and a cleaning position P3) in a drum rotation direction with respect to the primary transfer position P1 (position opposite the primary transfer roller 14) of the photosensitive drum 11 in the image formation units 10. The direction of the light-emitting diodes 35 for the pre-transfer neutralization is set such that the neutralization light L2 emitted from the light-emitting diodes 35 is applied to the upstream side (more specifically, between the primary transfer position P1 and a development position P4) in the drum rotation direction with respect to the primary transfer position P1 (see FIG. 4) of the photosensitive drum 11 in the image formation units 10. In the optical path of the pre-transfer neutralization light L2 for the pre-transfer neutralization, light amount control wall portions 40 are provided.

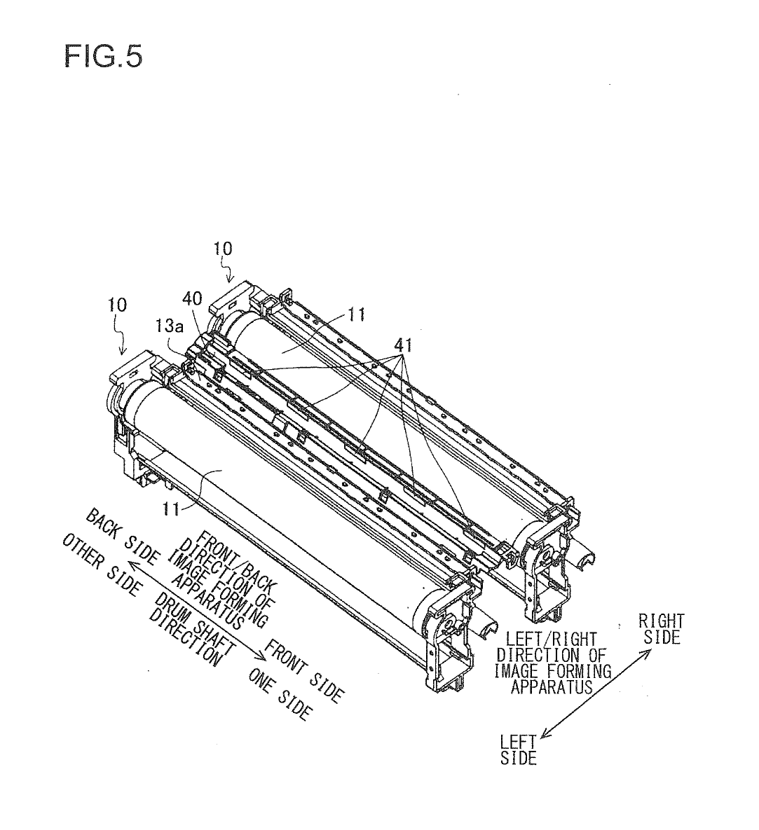

As shown in FIG. 5, the light amount control wall portion 40 is formed on the upper surface of the development device 13 provided between the photosensitive drums 11 adjacent to each other. Specifically, the light amount control wall portion 40 is formed integrally with an upper side cover portion 13a forming an upper wall portion of the development device 13. The light amount control wall portion 40 is extended in the drum shaft direction, and the length thereof is substantially equal to the length of the photosensitive drum 11 in the direction of the shaft.

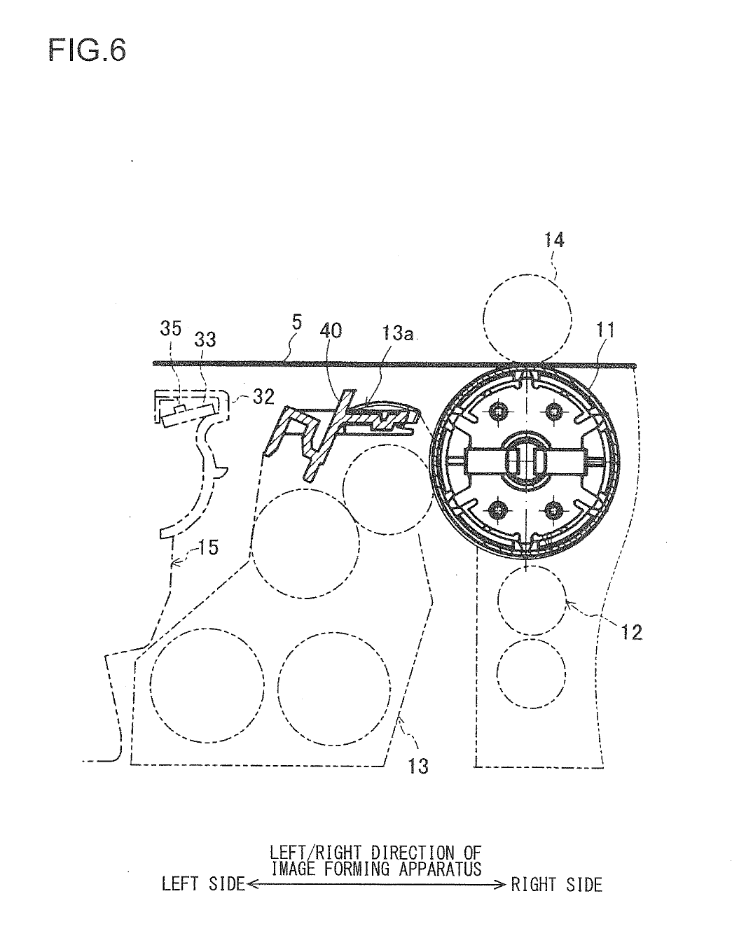

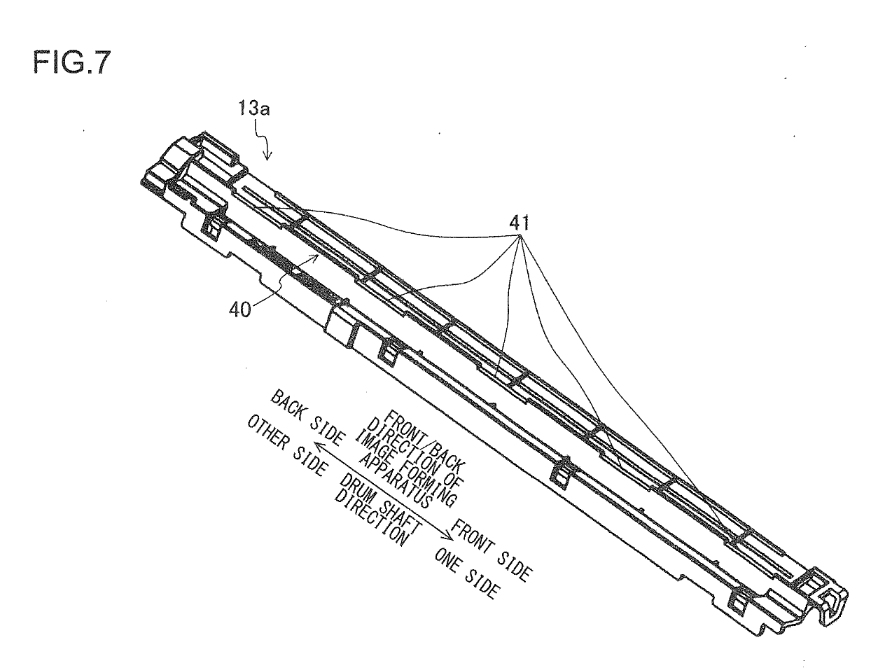

As shown in FIGS. 6 and 7, the light amount control wall portion 40 is inclined upwardly to the right side. In the light amount control wall portion 40, a plurality of cut portions 41 are formed in an upper end portion of a rectangular plate in which the height from the lower end to the upper end is constant. The cut portions 41 are formed at regular intervals in the longitudinal direction (the drum shaft direction) of the light amount control wall portion 40. Each of the cut portions 41 is formed in the shape of a rectangle that is opened upwardly when seen in the direction of the thickness of the light amount control wall portion 40.

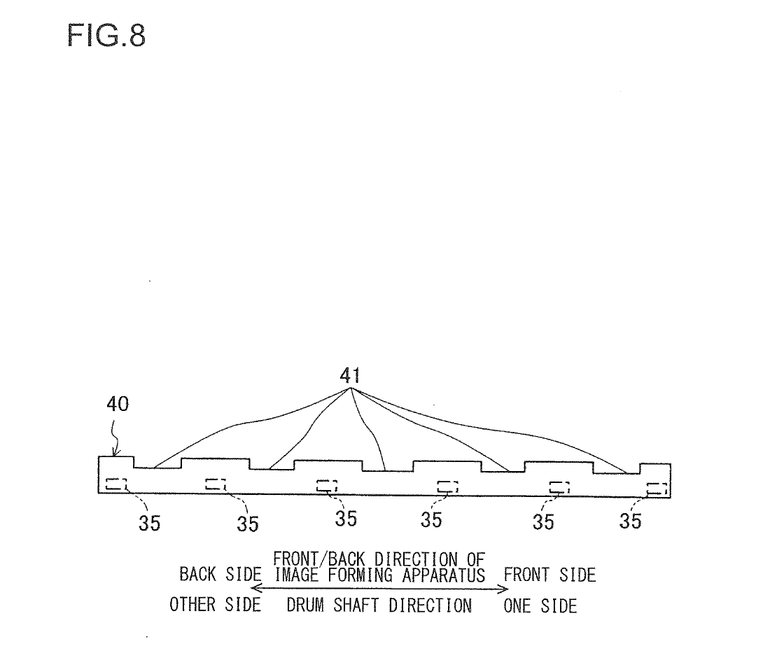

FIG. 8 schematically shows a positional relationship between the cut portions 41 and the light-emitting diodes 35 for the pre-transfer neutralization. As shown in the figure, the cut portions 41 are formed in the corresponding portions between the light-emitting diodes 35 adjacent to each other in the light amount control wall portion 40. On the other hand, in the portions corresponding to the light-emitting diodes 35 in the light amount control wall portion 40, the cut portions 41 are not provided. Hence, the pre-transfer neutralization light L2 is easily transmitted by the portions where the cut portions 41 are formed as compared with the other portions. The width and the height of the cut portions 41 are set such that the amount of pre-transfer neutralization light L2 on the circumferential surface of the photosensitive drum 11 is constant in the drum shaft direction.

Hence, in the present embodiment, the amount of pre-transfer neutralization light L2 on the circumferential surface of the photosensitive drum 11 can be made constant in the drum shaft direction. In other words, when the light amount control wall portion 40 is not provided, as compared with the portions corresponding to the light-emitting diodes 35, in the corresponding portions between the light-emitting diodes 35 adjacent to each other on the circumferential surface of the photosensitive drum 11, the amount of pre-transfer neutralization light L2 is decreased. Hence, variations in the amount of pre-transfer neutralization light L2 on the circumferential surface of the photosensitive drum 11 are produced in the drum shaft direction. By contrast, in the present embodiment, in the optical path of the neutralization light L2 travelling from the light-emitting diodes 35 for the pre-transfer neutralization to the photosensitive drum 11, the light amount control wall portions 40 extending in the drum shaft directions are arranged, and the corresponding portions between the light-emitting diodes 35 adjacent to each other in the light amount control wall portion 40 are formed in such a shape (in the embodiment described above, the cut shape) that as compared with the portions corresponding to the light-emitting diodes 35 in the light amount control wall portion 40, the neutralization light L2 is easily transmitted. Thus, it is possible to remove variations in the amount of pre-transfer neutralization light L1 on the circumferential surface of the photosensitive drum 11 and to reliably and uniformly remove, with the neutralization device 30, the residual charge on the circumferential surface of the photosensitive drum 11. Moreover, in the present embodiment, since a plurality of cut portions 41 are only formed in the light amount control wall portion 40, it is possible to remove variations in the amount of light with a simple configuration.

In the present embodiment, since only in the optical path of the pre-transfer neutralization light L2, the light amount control wall portion 40 is provided, it is possible to reduce the product cost. In other words, since the amount of pre-transfer neutralization light L2 is lower than the amount of post-transfer neutralization light L1, in the pre-transfer neutralization, variations in the amount of neutralization light L2 on the circumferential surface of the photosensitive drum 11 are easily produced as compared with the post-transfer neutralization. In the present embodiment, with consideration given to this point, only in the optical path of the pre-transfer neutralization, the light amount control wall portions 40 are provided, and thus the number of light amount control wall portions is minimized, with the result that the product cost is reduced.

In the present embodiment, the light amount control wall portion 40 is formed on the upper surface of the development device 13. In this way, since in a dead space between the upper surface of the development device 13 and the intermediate transfer belt 5, the light amount control wall portion 40 can be formed, it is possible to reduce the size of the entire image forming apparatus 1. Since the light amount control wall portion 40 can be formed by utilizing part of the upper side cover portion 13a of the development device 13, it is possible to reduce the product cost by using the same component so as to have different functions.

### Second Embodiment

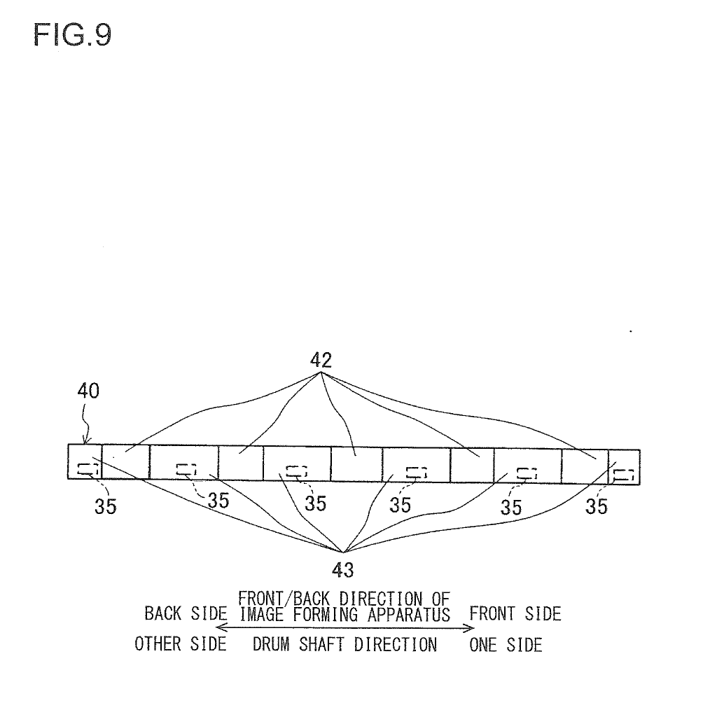

FIG. 9 shows a second embodiment. In this embodiment, the shape and the material of the light amount control wall portion 40 differ from those in the first embodiment. The same constituent portions as in FIG. 8 are identified with the same symbols, and their detailed description will be omitted.

Specifically, in the present embodiment, the light amount control wall portion 40 is extended parallel to the drum shaft direction, and is formed with a rectangular plate portion whose height from the lower end edge to the upper end edge is constant. The corresponding portions between the light sources 35 adjacent to each other in the light amount control wall portion 40 are formed with a first translucent portion 42. On the other hand, the portions corresponding to the light sources 35 in the light amount control wall portion 40 are formed with a second translucent portion 43. The optical transmittance of the first translucent portion 42 is set higher than that of the second translucent portion 43 (the first translucent portion 42 transmits light more easily than the second translucent portion 43) such that the amount of pre-transfer neutralization light L2 on the circumferential surface of the photosensitive drum 11 is constant in the drum shaft direction. In the present embodiment, the first translucent portion 42 is formed with a transparent member whose surface is flat, and the second translucent portion 43 is formed with a member whose surface is grained and which is formed in the shape of a ground glass. In this configuration, it is possible to reduce variations in the amount of neutralization light on the circumferential surface of the photosensitive drum with a simple configuration without complicating the shape of the light amount control wall portion. Hence, it is possible to obtain the same actions and effects as in the first embodiment.

### Other Embodiments

Although in the first embodiment, the cut portion 41 is formed in the shape of a rectangle, there is no limitation on this configuration. For example, the cut portion 41 may be formed in the shape of a circle or a triangle.

Although in the second embodiment, the first translucent portion 42 and the second translucent portion 43 are formed in the light amount control wall portion 40, instead of the second translucent portion 43, a light-shielding portion that does not transmit light at all may be adopted.

Although in the embodiments described above, the example where the light amount control wall portions 40 are provided in the optical path of the pre-transfer neutralization light L2 is described, there is no limitation on this configuration. For example, the light amount control wall portions 40 may be provided in the optical path of the post-transfer neutralization light L1.

Although in the embodiments described above, the light amount control wall portion 40 is formed on the upper surface of the development device 13, there is no limitation on this configuration. For example, part of the light source cover 32 may also be used as the light amount control wall portion 40. In this way, as compared with the case where the light amount control wall portion 40 is formed in the limited space between the development device 13 and the intermediate transfer belt 5, the flexibility of the shape of the light amount control wall portion is enhanced. The light source cover 32 is also used as the light amount control wall portion 40, and thus it is possible to further reduce the product cost.

When the light amount control wall portion 40 is not provided, the amount of neutralization light on the corresponding portions between the light sources adjacent to each other on the circumferential surface of the photosensitive drum 11 is lower than the amount of neutralization light on the portions corresponding to the light sources. Hence, variations in the amount of neutralization light on the circumferential surface of the photosensitive drum 11 are produced in the drum shaft direction. By contrast, in the configuration of the present disclosure, in the optical path of the neutralization light travelling from the light sources to the photosensitive drum 11, the light amount control wall portions 40 extending in the drum shaft direction are arranged, and the corresponding portions between the light sources adjacent to each other in the light amount control wall portion 40 are formed in such a shape or formed of such a material that as compared with the portions corresponding to the light sources, the light is easily transmitted, with the result that the amount of neutralization light on the circumferential surface of the photosensitive drum 11 cam be made constant in the drum shaft direction.

As described above, in the neutralization device of the present disclosure, in the optical path of the neutralization light travelling from the light sources to the photosensitive drum, the light amount control wall portions are provided, and thus the amount of neutralization light on the circumferential surface of the photosensitive drum cam be made constant in the drum shaft direction. Hence, in the present disclosure, it is possible to provide the neutralization device that can remove variations in the amount of neutralization light on the circumferential surface of the photosensitive drum to remove the residual charge reliably and uniformly.

In the neutralization method (the neutralization method of the present application) of the neutralization device configured as described above, the neutralization light is applied through the light amount control wall portions such that the amount of neutralization light on the circumferential surface of the photosensitive drum is made constant in the drum shaft direction. Hence, in the present disclosure, it is possible to provide the neutralization method that can reliably and uniformly remove the residual charge on the circumferential surface of the photosensitive drum.

The image forming apparatus of the present disclosure including the neutralization device configured as described above includes the photosensitive drum, the charging device, the development device, a plurality of image formation units included in the neutralization device, the transfer belt and the transfer roller. The neutralization device is configured to perform the pre-transfer neutralization and the post-transfer neutralization.

In this type of image forming apparatus, the amount of neutralization light for the pre-transfer neutralization is generally set lower than the amount of neutralization light for the post-transfer neutralization. Hence, in the pre-transfer neutralization in which the amount of neutralization light is low, as compared with the post-transfer neutralization, variations in the amount of neutralization light on the circumferential surface of the photosensitive drum are easily produced. Hence, the image forming apparatus is provided in which the light amount control wall portions are provided in the optical path of the neutralization light for the pre-transfer neutralization to reduce variations in the amount of neutralization light on the circumferential surface of the photosensitive drum and thus it is possible to remove the residual charge reliably and uniformly.

As described above, in the present disclosure, the amount of neutralization light on the circumferential surface of the photosensitive drum is made constant in the drum shaft direction, and thus it is possible to reliably and uniformly remove the residual charge on the circumferential surface of the photosensitive drum. Hence, the present disclosure is useful for a neutralization device and an image forming apparatus including a neutralization device.

What is claimed is:

1. A neutralization device that includes a plurality of light sources arranged a distance apart from each other in a direction of a shaft of a photosensitive drum and that applies neutralization light to a circumferential surface of the photosensitive drum from the light sources to neutralize the photosensitive drum, the neutralization device comprising:
a light amount control wall portion that is provided in an optical path of the neutralization light travelling from the light sources to the photosensitive drum and that is extended in the drum shaft direction,
wherein corresponding portions between the light sources adjacent to each other in the light amount control wall portion are formed in such a shape or formed of such a material that an amount of the neutralization light on the circumferential surface of the photosensitive drum is made constant in the drum shaft direction, and that as compared with portions corresponding to the light sources in the light amount control wall portion, the neutralization light is easily transmitted.

2. The neutralization device according to claim 1,
wherein the corresponding portions between the light sources adjacent to each other in the light amount control wall portion are formed in a shape of a cut such that as compared with the portions corresponding to the light sources in the light amount control wall portion, the neutralization light is easily transmitted.

3. The neutralization device according to claim 1,
wherein the light amount control wall portion is extended parallel to the drum shaft direction, and is formed in a shape of a rectangle whose height from a lower end edge to an upper end edge is constant, and
the corresponding portions between the light sources adjacent to each other in the light amount control wall portion are formed of such a material that as compared with the portions corresponding to the light sources in the light amount control wall portion, an optical transmittance is high.

4. An image forming apparatus comprising:
a plurality of image formation units each including a photosensitive drum that is driven to rotate in a predetermined rotation direction, a charging device that charges the photosensitive drum, a development device that supplies a toner to a circumferential surface of the photosensitive drum and the neutralization device of claim 1 that neutralizes the photosensitive drum;
an endless transfer belt that makes contact with a plurality of the photosensitive drums in the image formation units and that is driven to rotate while a circumferential surface thereof is in contact with the photosensitive drums; and
a plurality of transfer rollers that are arranged through the transfer belt opposite the photosensitive drums and that transfer a toner image to the transfer belt,
wherein the neutralization device performs pre-transfer neutralization in which the neutralization light is applied to an upstream side in the rotation direction with respect to a position on the circumferential surface of the photosensitive drum opposite the transfer roller and post-transfer neutralization in which the neutralization light is applied to a downstream side in the rotation direction with respect to the position on the circumferential surface of the photosensitive drum opposite the transfer roller,
an amount of the neutralization light for the pre-transfer neutralization is set lower than an amount of the neutralization light for the post-transfer neutralization and
the light amount control wall portion is provided in an optical path of the neutralization light for the pre-transfer neutralization.

5. The image forming apparatus according to claim 4,
wherein the light amount control wall portion is formed on an upper surface of the development device.

6. A neutralization method of the neutralization device according to claim 1,
wherein when the neutralization light is applied from the light sources to the circumferential surface of the photosensitive drum to neutralize the photosensitive drum, in the optical path of the neutralization light travelling from the light sources to the photosensitive drum, the light amount control wall portion extending in the drum shaft direction is provided, the corresponding portions between the light sources adjacent to each other in the light amount control wall portion are formed in such a shape or formed of such a material that as compared with the portions corresponding to the light sources, the light is easily transmitted and the amount of the neutralization light on the circumferential surface of the photosensitive drum is made constant in the drum shaft direction.
